(19) United States
(12) Patent Application Publication
(10) Pub. No.: US 2024/0239223 A1
(43) Pub. Date: Jul. 18, 2024

(54) GROUND NAVIGABLE INDUCTIVE CHARGING SYSTEM ADAPTED FOR OPERATION BENEATH ELECTRIC VEHICLES FOR WIRELESSLY CHARGING

(71) Applicant: EV CHARGING SOLUTIONS LLC, Albuquerque, NM (US)

(72) Inventors: Luis M. Ortiz, Albuquerque, NM (US); Kermit D. Lopez, Albuquerque, NM (US)

(21) Appl. No.: 18/406,078

(22) Filed: Jan. 5, 2024

Related U.S. Application Data
(60) Provisional application No. 63/438,731, filed on Jan. 12, 2023.

(51) Int. Cl. B60L 53/38; B60L 53/12; B60L 53/62; H02J 7/00; H02J 50/10; H02J 50/90

(52) U.S. Cl. CPC B60L 53/38; B60L 53/12; B60L 53/62; H02J 7/0049; H02J 50/10; H02J 50/90

(57) ABSTRACT

An apparatus for charging an electric vehicle, can include a robotic system including a charge transmitting coil autonomously navigable along a ground surface to interface with a charge receiving coil mounted underneath an electric vehicle (EV). The robotic system can be automatically moveable and directable from storage against a wall toward a target area on the electric vehicle associated with a receiving coil mounted on the EV for the charging of the EV when the transmitting coil engages closely with the receiving coil when the robotic system becomes located below the charge receiving coil mounted to the EV. One or more optical sensors can be utilized to direct the robotic system toward the target area.

### CROSS-REFERENCE TO PROVISIONAL APPLICATION

This patent application claims priority under 35 U.S.C. § 119(e) to U.S. Provisional Patent Application Ser. No. 63/438,731 entitled “Ground Navigable Inductive Charging System Adapted for Charging Beneath Electric Vehicles for Wireless Charging,” which was filed on Jan. 12, 2023, the disclosure of which is incorporated herein by reference in its entirety.

### TECHNICAL FIELD

Embodiments are related to electric vehicles and more particularly to the charging of electric vehicles. Embodiments also relate to infrastructure for inductive wireless charging of electric vehicles. Embodiments further relate to wireless inductive charging of electric vehicles at their underside using an X-Y-Z manipulatable robotic charging platform.

### BACKGROUND

Unlike gasoline and diesel vehicles, which can use a service station, electric vehicles require recharging either from special connectors installed at a residence, or at special charging stations that can be found at designated locations. Finding these locations can be difficult and time consuming and with the limited range that an electric vehicle is handicapped with, long distance travel becomes complex if not impossible. The necessary infrastructure of charging stations is not adequately present, nor is the ease of use and implementation of charging systems in residences or in public and commercial settings.

Furthermore, the charging of the rechargeable battery within the electric vehicle takes much more time than the application of gasoline or diesel to an international combustion engine's fuel tank. Hence, the need by an owner of an electric vehicle to remember to charge the electric vehicle overnight at his or her residence. If the owner does not remember to plug in, then they will surely be late as they must wait to get an adequate charge the next day or will suffer from range anxiety because they are not sure if they will make it to their destination without an adequate charge.

Some home charging systems typically involve the use of a Level 2 charger (e.g., a 240-volt source that typically can add 25 or more miles of driving range per hour) that an electric vehicle owner can control, and which can be available for use based on the household's schedules (e.g., overnight when electric rates are lower), thereby reserving public charging for short-term needs around town or for distance traveling. Lower voltage (e.g., 110 V) systems for slow overnight charging are also available. Home charging systems can be cumbersome and can take up space in, for example, a home carport or garage. Stations are typically wall or ground mounted and require the handling of cables to connect to and plug into electric vehicles. Furthermore, either the wall- or ground-mounted units and associated cables can be in the way of human movement around the electric vehicle or within a garage installment.

One solution for both home charging and public charging scenarios, involves inductive power transfer (IPT) systems for the wireless transfer of energy. IPT systems also referred to as electromagnetic power charging systems include a primary (or “base”) power device (e.g., electromagnetic power transmitting device) that can transmit power to a secondary (or “pick-up”) power receiver device (e.g., electromagnetic power receiving device). Each of the electromagnetic power transmitter and receiver devices can include inductors, typically coils or windings of electric current conveying media. An alternating current in the primary inductor (the electromagnetic power transmitting device) produces a fluctuating electromagnetic field. When the secondary inductor (electromagnetic power receiving device) is placed in proximity to the primary inductor (electromagnetic power transmitting device), the fluctuating electromagnetic field induces an electromotive force (EMF) in the secondary inductor, thereby transferring power to the electromagnetic power receiving device.

IPT systems for inductive charging of electric vehicle batteries typically require the use of ground-based (e.g., subsurface installation, or laying statically on top of the ground) wireless charging devices. Such charging systems are provided in the format of pads laying on the ground beneath electric vehicles and/or charging coils implemented in a ground-based assembly also located beneath/underneath an electric vehicle. A problem with an in-ground approach is that concrete or pavement in existing parking spaces needs to be modified to install a system. A problem with above ground systems (i.e., systems, such as pads, laying on top of a garage surface) is that these can present trip points to pedestrians traversing over the ground, which can present legal liability to a premises with such an installation. Furthermore, accurate placement of the vehicle over the charging infrastructure becomes necessary for electromagnetic charging beneath the electric vehicle to work properly/efficiently. In these fixed installments, an electric vehicle equipped with an under-carriage charging receiver must be driven precisely into place above the ground-based charging assembly to charge the electric vehicle through wireless inductive charging. If too much distance is place between the transmitter and receiver, or it's the receivers x-y orientation above the charging coil is not precise, the system will operate less efficiently.

What is needed are electromagnetic charging systems and methods thereof that do not need to be installed inground, can automatically compensate for lack of precise vehicle orientation of receiving coils over charging coils, can close the gap between charging coil and receiving coil for more efficiency, and can overcome the limitations of requiring user handling of cables in cable-based charging systems.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and Abstract as a whole.

It is, therefore, an aspect of the embodiments to provide for an improved electric vehicle charging system that is based on wireless electromagnet charge transfer from a charging coil that can manipulate in x-y-z directions underneath a parked vehicle to compensate for imprecise parking of the vehicle and can close the gap between transmitting coil and receiving coil.

In an embodiment, the electromagnetic power transmitting device can include a charging pad (which can include a charge transmitting coil therein) that can magnetically engage with the at least one electromagnetic power receiving device (which can include a charge receiving coil therein).

It is another aspect of the embodiments to provide for an improved electric vehicle charging system that is based on wireless electromagnet charge transfer from an electromagnetic power transmitting coil to an electromagnetic power receiving coil and does not require fixed installation within a ground surface located beneath electric vehicles.

It is another aspect of the embodiments to provide for an improved electric vehicle charging system that is based on electromagnet charge transfer and can be located as part of a robotic system locatable (e.g., installed, mounted, positioned) on or near building infrastructure (e.g., garage walls) in a manner to stow and then deploy to wirelessly charge electric vehicles from underneath the electric vehicle (e.g., provide charge at an electromagnetic power receiving coil mounted underneath electric vehicles from a robotically manipulable electromagnetic power transmitting coil).

It is a further aspect of the embodiments to provide for an improved electric vehicle charging system that is based on electromagnet charge transfer from an electromagnetic power transmitting coil and which can be located in front of or at a side of an electric vehicle (e.g., at the front or side walls of a garage housing an EV, etc.) and the electromagnetic power transmitting coil can be robotically manipulated in X-Y-Z direction to place an electromagnetic power transmitting coil near or into contact with an electromagnetic power receiving coil located/installed beneath the electric vehicle.

The aforementioned aspects and other objectives and advantages can now be achieved as described herein. In an embodiment, an apparatus for charging an electric vehicle, can include a receptacle (i.e., system housing) located near or mountable to a wall (e.g., e.g., front or side walls in a garage) located near an electric vehicle, wherein the receptacle maintains an electromagnetic power transmitting device, which can be automatically moveable and directable from the receptacle located at a side of the EV toward electromagnetic power receiving coil mounted underneath the electric vehicle for the charging of an electric vehicle when the at least one electromagnetic power receiving device is engaged by the electromagnetic power transmitting device when it is moved by robotic manipulation in X-Y-Z directions.

In an embodiment, the electromagnetic power transmitting device can automatically engage with the at least one electromagnetic power receiving device located underneath the electric vehicle to wireless charge the electric vehicle and can automatically disengage from the at least one electromagnetic power receiving device and retract to the receptacle after charging of the electric vehicle is completed or terminated.

In an embodiment, the receptacle can comprise an EV charging system mounted to the ground underneath a carport or bay under which the electric vehicle can park for charging of the electric vehicle by the electromagnetic power transmitting device, wherein the structure may comprise a carport or bay currently found in residential and commercial settings.

In an embodiment, an apparatus for charging an electric vehicle, can include a receptacle mountable to a structure operable to deploy an electromagnetic power transmitting device underneath an electric vehicle, wherein the receptacle maintains the electromagnetic power transmitting device, which can be electromechanically movable and directable from the receptacle toward a target area on the electric vehicle associated with at least one electromagnetic power receiving device mounted underneath the electric vehicle for charging the electric vehicle when the electromagnetic power transmitting device is placed near and/or in contact with the electromagnetic power receiving device.

In an embodiment, charging, or the transfer of charge, can occur bidirectionally so that the electric vehicle can act as a power supply for a premises associated with the electric vehicle charging system, wherein the at least one receiving coil can when needed be operable to transmit an electrical current from the electric vehicle's batteries to the electromagnetic power transmitting device associated with the charging station for providing electric power from the electric vehicle to a premises associated with (and electronically connected via the premises' electric service) the charging station.

In another embodiment, a method for charging an electric vehicle, can involve: moving an electromagnetic power transmitting device in an X-Y-Z direction from a ground position underneath an electric vehicle to interface with an electromagnetic power receiving device coupled to an undersurface of the electric vehicle; and moving the electromagnetic power transmitting device to find a target area underneath the electric vehicle associated with a charge receiving coil integrated with the electromagnetic power receiving device and connected to the electric vehicle for the charging of the electric vehicle when the electromagnetic power transmitting device engages with the electromagnetic power receiving device. Note that the aforementioned ‘moving’ steps or operations may be performed with the assistance of a robotic device, i.e., a robot. Such ‘moving’ steps or operations may in some operations be performed automatically.

An embodiment of the method may also involve automatically disengaging the charge transmitting device from the electromagnetic power receiving device and retracting the charge transmitting device to a docking station after charging of the electric vehicle.

In an embodiment of the method, the target area may comprise an electromagnetic field.

In an embodiment of the method, the target area may include an electromagnetic target.

In an embodiment of the method, target area may include a radio frequency (RF) target.

In an embodiment of the method, the target area may be an optically recognizable target.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1 illustrates a schematic view of an aspect of an electric vehicle charging system that includes an electromagnetic power receiving device in the form of an electric vehicle charging pad apparatus including a charging coil integrated with or into the charging pad for receiving electromagnetic energy and a target area representing the center of the charging coil, in accordance with an embodiment;

FIG. 2 illustrates a side view of the electric vehicle shown in FIG. 2 with the electric charging pad apparatus mounted underneath the electric vehicle and an inductive wireless charge transmitting system navigable (X-Y-Z) on a floor beneath the electric vehicle, in accordance with an embodiment;

FIG. 3 illustrates a high-level view of an electric vehicle and primary vehicle subsystems that can be contained therein, in accordance with an embodiment;

FIG. 4 illustrates a block diagram depicting operational components of the charging receptacle, in accordance with an embodiment

FIG. 5 illustrates a top view of an electromagnetic power transmitting device, in accordance with an embodiment;

FIG. 6 illustrates a side view of an electromagnetic power transmitting device, in accordance with an embodiment;

FIG. 7 illustrates a side view of an electromagnetic power transmitting device, in accordance with another embodiment;

FIG. 8 illustrates a side view of an electromagnetic power transmitting device, docking station for the electromagnetic power transmitting device, and the electromagnetic power transmitting device interfacing by X-Y-Z movement with a charge receiving device associated with an electric vehicle, in accordance with an embodiment;

FIG. 9 illustrates a side view of an electromagnetic power transmitting device docking station, in accordance with an embodiment;

FIG. 10 illustrates a front view of an electromagnetic power transmitting device docking station retrieving an electromagnetic power transmitting device, in accordance with an embodiment; and

FIG. 11 illustrates a garage with an electric vehicle charging system installment options in front of and at the side of an electric vehicle parked within a garage, carport or bay, in accordance with an embodiment.

Like reference numerals or reference symbols in the various drawings may indicate like or similar elements.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “data” as utilized herein can relate to physical signals that can indicate or include information. The term “data” can also relate to individual facts, statistics, or items of information, often numeric. In a more technical sense, data can be a set of values of qualitative or quantitative variables about one or more persons or objects, while a datum is a single value of a single variable. The term ‘data’ may also relate to the quantities, characters, and/or symbols on which operations can be performed by a computer, processor and/or application, with the data being stored and transmitted in the form of electrical signals and recorded on magnetic, optical, or mechanical recording media.

The terms “electric vehicle” and “EV” as utilized herein may be used interchangeably and can refer to all electric vehicles. Furthermore, the terms “battery”, “cell”, “battery cell”, and “battery pack” may be used interchangeably and refer to any of a variety of different rechargeable cell chemistries and configurations including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other battery type/configuration.

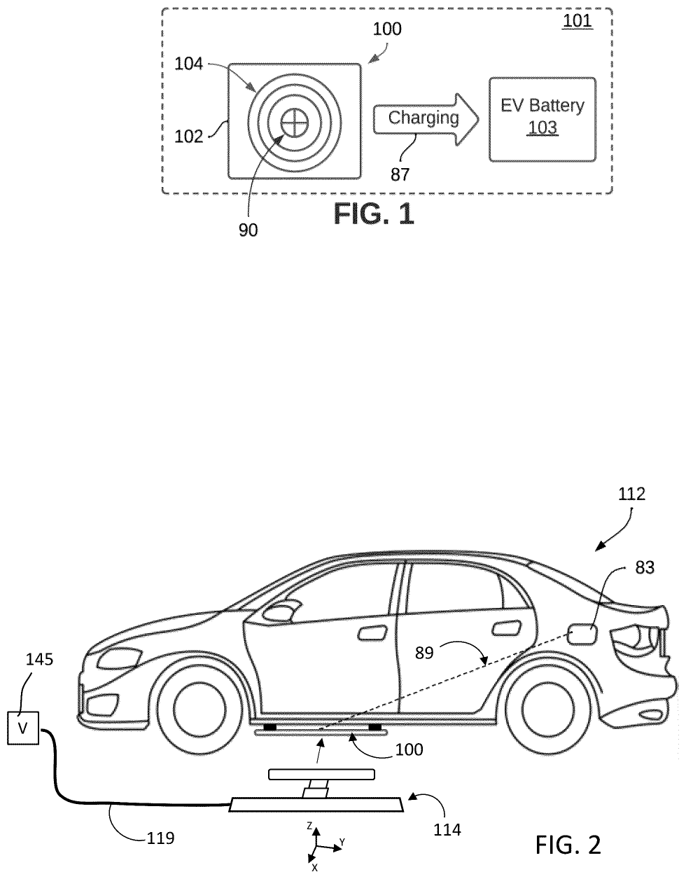

Referring to FIG. 1, illustrated is a schematic view of an electric vehicle (EV) charging system 101 that includes an electromagnetic power receiving device 100 (also may be referred to herein as an EV charging pad) that can include a charging pad 102 and a charge receiving coil 104 integrated with or into the charging pad 102, in accordance with an embodiment. The charging pad 102 can be formed from a flexible but durable material such as rubber, a synthetic material, a polymer, an elastomer (e.g., thermoplastic elastomer), silicone, etc. The material that can form the charging pad 102 can preferably be non-conducting and can also serve to insulate the charge receiving coil 104, which can be an induction coil. A target area 90 can indicate the center of the charge receiving coil 104. The target area can be located by a charge transmitting device. The target area 90 can include means for indicating the center to charge transmitting device (e.g., sensor, transmitters, indicia for optical recognition assist).

Note that the term ‘inductive charging’ as utilized herein can relate to the wireless transfer of energy through inductive coupling. That is, in an inductive charging application, alternating current can pass through the charging coil 104 (e.g., induction coil) in the charging pad 102. The moving electric charge creates a magnetic field, which can fluctuate in strength because the current's amplitude is fluctuating. This changing magnetic field can create an alternate electric current in the charging coil 104, which in turn can pass through a rectifier (not shown in FIG. 1) to convert it to direct current. The direct current can charge an electric vehicle (EV) battery 103 or can provide operating power.

Charging of the EV battery 103 by the electromagnetic power receiving device 100 is indicated by arrow 87 in FIG. 1. The arrow 87 represents various circuits, electrical cabling and wires, and components (e.g., such as the aforementioned rectifier or rectifiers, and on board controllers) that can facilitate charging of the EV battery 103 by the electromagnetic power receiving device 100 (also see charging system module 615 in FIG. 10).

Referring to FIG. 2, illustrated is a side view of the electric vehicle 112 with the electromagnetic power receiving device 100 mounted underneath the electric vehicle 112 and an electromagnetic power transmitting device 114 navigable (X-Y-Z) on a floor 130 beneath the electric vehicle 112, in accordance with an embodiment. The electromagnetic power receiving device 100 can be integrated into or mounted underneath an electric vehicle 112 in aftermarket or during EV manufacturing.

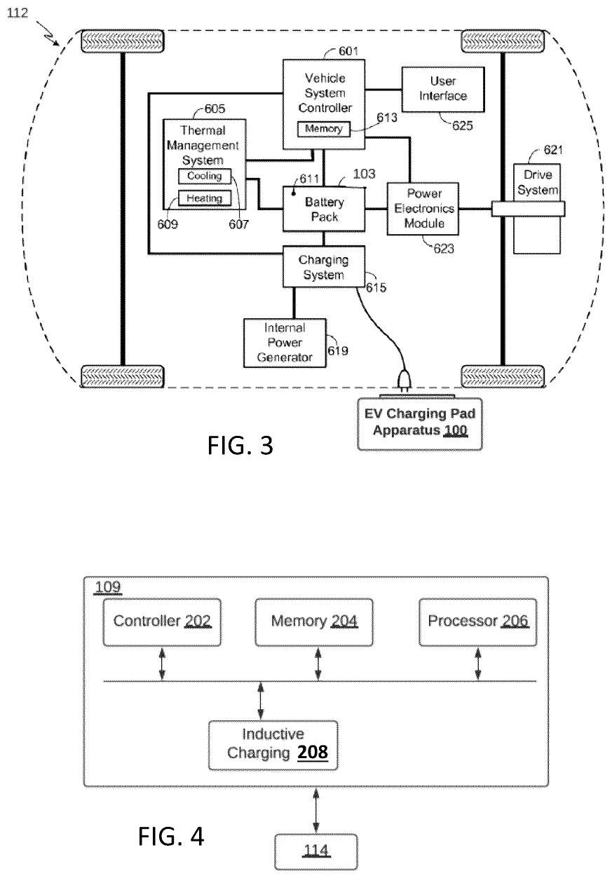

An electromagnetic power receiving device 100 can be connected electrically to the electrical charging system module (e.g., see charging system 615 shown in FIG. 3) of the electric vehicle 112. The charging coil 104 contained on or in the charging pad 102 can also be electrically connected to wiring associated with the electric vehicle's charging port 83, as indicated by dashed line 89 in FIG. 2. The dashed line 89 represents, for example, an aftermarket electrical connection between the charging system 615 associated with the electric vehicle 112 and the charging coil 104. In an embodiment, the electrical wiring and cabling that may be necessary to implement an aftermarket electrical connection between the charging coil 104 and the charging port 89 (and hence, a charging system module of the charging system 615 of the electric vehicle 112), can be professionally hidden during installation of an aftermarket implementation of an embodiment and can be directly connected to the electronics of the electric vehicle's charging system 615.

FIG. 3 illustrates a high-level view of the electric vehicle 112 and primary vehicle subsystems, in accordance with an embodiment. It will be appreciated that the electric vehicle 112 can utilize other subsystem configurations while still retaining the capabilities of the embodiments. As shown, the electric vehicle 112 can include a vehicle control system 601 that can monitor and control the general operation of the various vehicle subsystems.

System controller 601 can be coupled to the battery pack 103 and a thermal management system 605. Thermal management system 605, which preferably includes both a cooling subsystem 607 and a heating subsystem 609, can be used to control battery pack temperature and can be preferably coupled to other vehicle thermal systems, e.g., drive train cooling, passenger cabin HVAC system, etc. In some embodiments, the controller 601 among a variety of controlling operations, may monitor the temperature of the cells within the battery pack 103 using one or more sensors 611 and can control the temperature of the battery pack 103 (i.e., ‘the battery’) using thermal management system 605 in order to achieve a desired battery pack operating and/or storage temperature.

In addition to monitoring battery pack temperature, vehicle control system 601 can also monitor the state of charge (SOC) of battery pack 103 as well as the rate of battery discharge, both during vehicle operation and vehicle storage. In addition, in at least one embodiment the system 601 can monitor and store in an on-board memory 613 the number of charging cycles to which the battery has been subjected. Preferably for each charging cycle the cut-off voltage and other charging parameters are monitored and stored in memory 613, thereby providing information that can be used to gauge the relative health of battery pack 103 throughout its expected lifetime.

Control system 601 can be coupled to a charging system 615 that controls and monitors cut-off voltage during charging. Charging system 615 may also control and monitor the charge rate. Charging system 615 may either be an external system or integrated within vehicle control system 601. In at least one embodiment, charging system 615 is external to the control system 601. In such an embodiment, preferably the portion of the charging module that converts external power to a power level (e.g., voltage) that is compatible with battery pack 103 is external to the vehicle while a second portion of the charging module that controls charging characteristics such as cut-off voltage, charging rate, etc. is internal to the vehicle. Alternately, the entire charging module can be external to the power control subsystem 601 and the vehicle.

In an embodiment, the battery pack 103 can connect electrically to the electromagnetic power receiving device 100 for electrical connection to the charging coil 104 contained on or integrated with the charging pad 102 as discussed previously herein. Electrical connection between the battery pack 103, charging system 615 and the electromagnetic power receiving device 100 can be facilitated by a charging system 615 associated with the electric vehicle 112.

The charging system 615 can ensure that the power provided via wireless inductive charging as discussed previously can be, if necessary, converted to a form of power storable by the battery pack 103. For example, the charging system 615 typically includes an AC to DC rectifier in order to convert power to that required by battery pack 103. In an embodiment, the battery pack 103 may be charged in whole or in part by a power generator 619 if one is contained within the vehicle, i.e., an on-board power generator, which is coupled to the battery pack via charging system 615.

It will be appreciated that in some embodiments, while an external power source may be preferred for providing a full charge to battery pack 103, the power generator 619 (e.g., an internal power source) can be used to augment the charge within the battery pack 103, for example by charging battery pack 103 during vehicle use, thereby extending driving range. In most cases, however, the battery pack 103 of the electric vehicle 112 may still require charging from an external power source such as facilitated by the electromagnetic power receiving device 100. Note that in some embodiments, the internal power source 619 may be a regenerative braking system.

The power control subsystem 601 can also control the power coupled from battery pack 103 to vehicle propulsion motor 621, for example using a power electronics module (PEM) 623. Power electronics module 623 is used to ensure that the power delivered to motor 621 has the desired voltage, current, waveform, etc. Thus, for example, PEM 623 preferably includes a DC to AC inverter, as well as the necessary control circuitry/processor to implement the various selectable modes as described in detail below. It will be appreciated that vehicle propulsion motor 621 can be comprised of a single electric motor or multiple electric motors.

User interface 625 is preferably integrated into the vehicle's user interface, although the user interface 625 can be implemented in other ways as described in detail below. The user interface 625 provides a means for a user to control the selection of the vehicle's operational mode as well as associated parameters. Preferably, the user interface 625 can also provide means for identifying which mode the vehicle is in at any given time, as described further below.

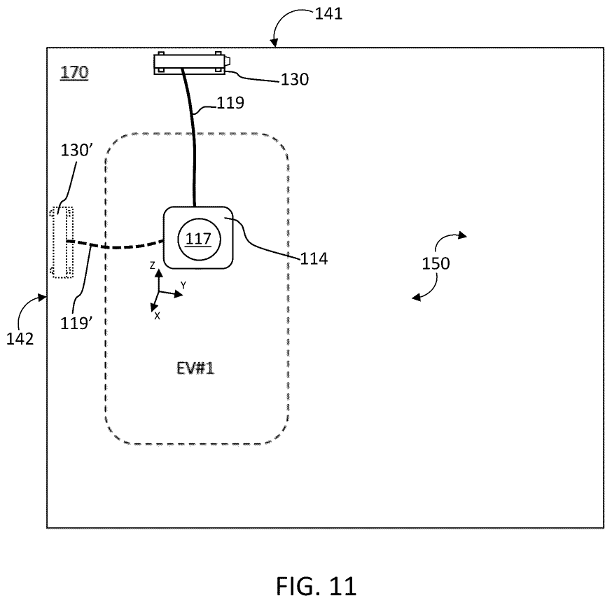

FIG. 4 illustrates a block diagram depicting operational components of the charging receptacle 109, in accordance with an embodiment. As shown in FIG. 11, the charging receptacle 109, which as indicated previously can be mounted to a ceiling of a structure such as a garage, a car port, a boom, or a bay, can include a controller 202 electronically and bidirectionally connected to a memory 204, a processor 206, and an inductive charging module 114. The processor 206 may be a processor such as, for example, a microprocessor or central processing unit (CPU) comprising electronic circuitry that executes instructions including a computer program. The processor 206 can perform arithmetic, logic, controlling and input/output (I/O) operations specified by the instructions in the computer program.

The memory 204 can server as storage (e.g., main memory, internal memory, prime memory, etc.) that is accessible by the processor 206. The processor 206 can read instructions stored in the memory 204 and then execute the instructions as required. Any data actively operated on can be stored in the memory 204 in a uniform manner. The memory 204 may be, for example random access memory (RAM) and/or read only memory (ROM). The controller 202 may be a hardware device and/or a software program that can manage or direct the flow data between two entities. The controller 202 can also comprise a microchip or hardware device operable to control other devices or components, such as, for example, the electromagnetic power transmitting device 114 including robotics and the charge transmitting coil 117. The controller 202 can also control the operations of an inductive charging module 208. In some embodiments, the controller 202 may be implemented as a microcontroller that can interface between two or more systems and manage communications between them.

The inductive charging module 208 can facilitate inductive wireless charging as discussed herein. That is, the inductive charging module 208 can provide electricity to the electromagnetic power transmitting device 114 robotically to the charge transmitting coil 117. The charging receptacle 109, which can include the inductive charging module 208, may be connected to an AC power outlet (such as available in an infrastructure of a garage). In some embodiments, the inductive charging module 208 may function as a power management module and/or an inductive power transfer (IPT) system power management module.

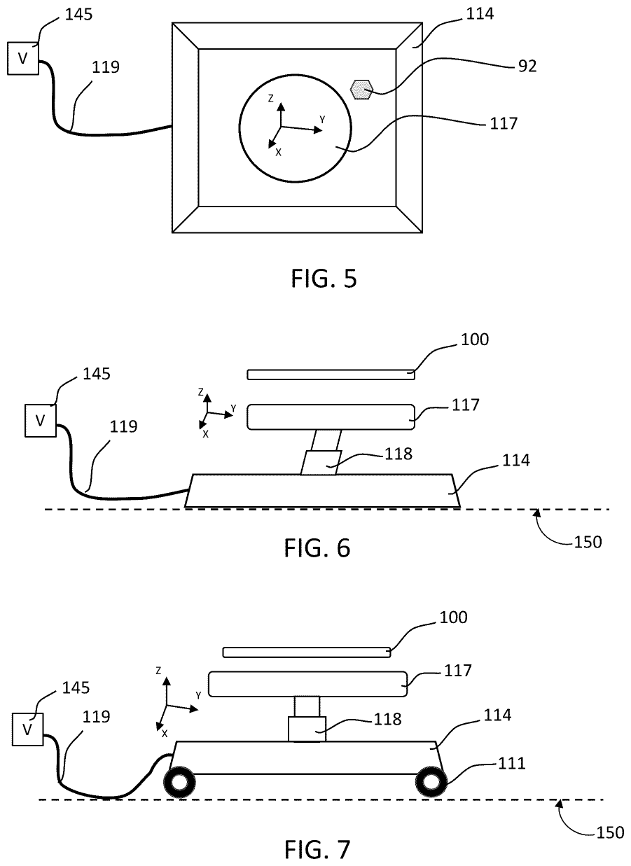

As mentioned hereinbefore, the center of the charging coil 104 can include a target area 90, which can be a marking such as, for example, a plus-shaped marking, or a marking of another shape (e.g., target, star symbol, hashtag, barcode, etc.). The target can also carry information identifying the electric vehicle (e.g., via hashtag or barcode). The target area 90 can be configured and operable as an optically recognizable target that can be recognized by one or more optical sensors (e.g., optical sensor 92 shown in and further discussed with respect to FIG. 5) associated with the electromagnetic power transmitting device 114.

Referring to FIG. 5, illustrated is a top view of an electromagnetic power transmitting device 114, in accordance with an embodiment. The electromagnetic power transmitting device 114 can be connected to a voltage source 145 by cable 119. The voltage source can be provided in the form of a 110 v outlet typically found in garages within the United States, as an example. A charge transmitting coil 117 can be integrated within the electromagnetic power transmitting device 114. The charge transmitting coil 117 can be moved in X-Y-Z directions within the electromagnetic power receiving device 100. The charge transmitting coil 117 can also be moved in X-Y-Z directions with the electromagnetic power receiving device 100 as will be discussed further.

The electromagnetic power receiving device 100 in the form of a charging coil 104 can be a wireless reception coil that can operate by inductive charging (also referred to as wireless charging or cordless charging) for receiving a wireless power transfer of energy (and in some applications such as bidirectional power transfer, can provide the transfer of energy). The charging coil 104 together with the charging pad 102 can form what can be referred to as an “inductive pad”. The charging coil 104 can function as a reception coil that receives energy wirelessly from an electromagnetic power transmitting device through inductive charging. Note that an example of an electromagnetic power transmitting device 114 would include a charge transmitting coil. The charging coil 104 can thus wirelessly receive energy from a transmitting charging coil such as the charge transmitting coil 117.

The electric vehicle 112 can include one or more batteries such as the EV battery 103 shown in FIG. 1. That is, the EV battery 103 may be used as a battery (or battery bank) for the electric vehicle 112. In the configuration shown in FIG. 2, the electromagnetic power receiving device 100 is shown located underneath, or on the underside of, the electric vehicle 112. The charging coil 104 of the electromagnetic power receiving device 100 can communicate electrically with the EV battery 103 associated with the electric vehicle 112 through charging system electronics 615 (see FIG. 3).

As an alternative to optically locating a vehicle embedded coil, wireless means of determining the location of the coil can be used. For example, RFID, NFC or other sensor-based technology can be utilized to locate a receiving coil within the skin of an electric vehicle. At least one sensor 92 can be configured to use wireless signals to home in on the location of the charging coil 104. Therefore, it can be appreciated that a combination of optical, wireless radio frequency, magnetic sensors could be utilized in place of sensors 92 discussed in FIG. 5. Sensors associated with the electromagnetic power transmitting device 114 can also detect the target area 90 in the form of signals from radio frequency transmitters, RFID tags, and electromagnetic emission generated by the EV to assist the electromagnetic power transmitting device 114 with finding the electromagnetic power receiving device 100. The charging coil 104 can serve as an electromagnetic source to assist in it being located by an electromagnetic power transmitting device 114 with a sensor configured to recognize and find the charging coil 104 as an electromagnetic source. The one or more sensors 92, such as optical sensors or cameras, can be used to identify the target area 90 (or center of the receiving coil 104) and guide the charging device 114 towards and upward against the charging coil 104 located on the charging pad 102. The charging device 114 can also be directed towards the charging coil 104 located on the charging pad 102 by RFID or other wireless means via sensors 92. Charging of the electric vehicle 112 thus can occur via movement of the charging device 114 underneath below the electric vehicle rather than being concerned with precise placement of an electric vehicle over a fixed charging transmitter as is presently implemented by in-ground or ground-mounted inductive power transfer (IPT) systems proposed by other entities in the art.

FIG. 6 illustrates a side view of an electric vehicle charging system 101 that includes a moveable hardware 118 connected to the charge transmitting coil 117, in accordance with an embodiment. These components can collectively represent an electromagnetic power transmitting device. The charge transmitting coil 117 is an induction coil that can function as electromagnetic energy transmitting coil. The electromagnetic power transmitting device 114 is a charge transmitting device that can automatically move in a generally upward direction as indicated by arrow to engage the charging coil 104 of the electromagnetic power receiving device 100 associated with the electric vehicle 112, with the charge transmitting coil 117 of the electromagnetic power transmitting device 114. Of course, movement of electromagnetic power transmitting device 114 can also be in x-y-z directions in order to accurately place a charging member next to the charging coil 104 located underneath and connected to the electric vehicle 112.

The electric vehicle charging system 101 can be implemented as a dynamic wireless electric vehicle charging system in which a wireless transfer of energy can occur through inductive charging between an electromagnetic power transmitting device 114 including the charge transmitting coil 117 and an electromagnetic power receiving device such as charging coil 104 (receiving coil) associated with the electric vehicle 112. Note that the upward direction indicated by arrow indicates a generally upward but three-dimensional direction (x-y-z) for the electromagnetic power transmitting device 114 toward the electromagnetic power receiving device 100, and in particular centering on the target area 90 location of the charging coil 104.

Referring to FIG. 7, illustrated is a side view of an electromagnetic power transmitting device 114, in accordance with an embodiment. Robotic manipulation can be accomplished by hardware that can include electromechanical hardware such as electromechanically manipulated wheels 111 to move the electromagnetic power transmitting device 114 horizontally (e.g., in X and Y directions) over a flat ground surface (e.g., garage floor) as well as electromechanical or pneumatic hardware 118, such as scissor lifts, screw drives, inflatable bladders, or other electromechanically or pneumatically controlled hardware (such as also shown in FIG. 5) to move the electromagnetic power transmitting device 114 and/or the transmitting coil 117 upward (e.g., in Z direction) when placing it into close contact with the charging coil 104 representing the electromagnetic power receiving device 100. Without limiting the scope of the embodiments, an example of electromechanical hardware that can achieve x-y-z manipulation in the form of a robotic unit that can includes a chassis having forward and rear ends and a drive system carried by the chassis. The drive system includes right and left driven wheels and is configured to maneuver the robot over a floor surface. A variety of systems, methods and devices than can be utilized to provide x-y-z manipulation, but that have been used for other purposes such as manufacturing and surgery and would not have been contemplated for such a novel and unobvious application as the inductive wireless charging of electric vehicles as taught herein.

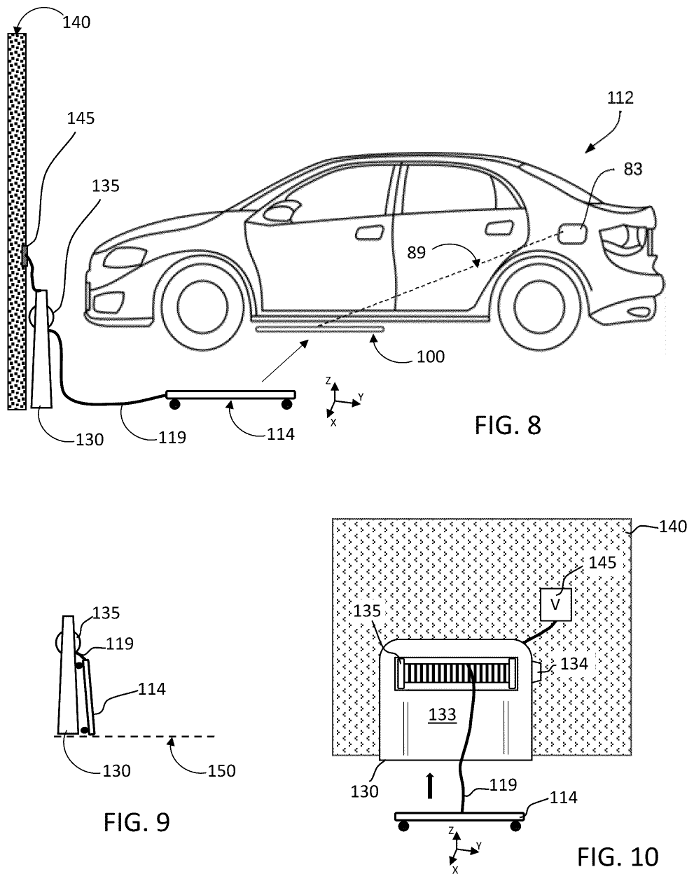

Referring to FIG. 8, illustrated is a side view of an electric vehicle 112 with an electromagnetic power receiving device 100 mounted underneath, and an electromagnetic power transmitting device 114 being moved into position underneath the electric vehicle 112 so that it can electromagnetically interface with the electromagnetic power receiving device 100. An electrical system 145 of a house (e.g., to wall plugs within a carport or garage) is typically represented by an electrical plug mounted to a wall. 140, which can be utilized to power the electromagnetic power transmitting device 114. Also shown in FIG. 7 is an optional docking station 130 that can operate to assist the electromagnetic power transmitting device 114 with movement to and from the electric vehicle 112. The docking station 130 can include a cable roller 135 that can facilitate extraction and retraction of the cable 119 providing power to the electromagnetic power transmitting device 114. The docking station 130 can include electrical circuitry and components that provide electrical power to the electromagnetic power transmitting device 114, including sensors 92, via the cable 119. In some embodiments, the sensors 92 can be powered by small rechargeable batteries encased in the electromagnetic power transmitting device 114.

Referring to FIG. 9, illustrated is a side view of an electromagnetic power transmitting device docking station, in accordance with an embodiment. The docking station 130 is shown standing upright on the ground 150 with the electromagnetic power transmitting device 114 in a stowed position resting against the docking station 130. The cable 119 for the electromagnetic power transmitting device 114 can be rolled up onto a spool 135 that can be integrated with the docking station 130. The spool 135 can be electromechanically controlled.

Referring to FIG. 10, illustrated is a front view of an electromagnetic power transmitting device docking station 135 that can be utilized for deploying and retrieving an electromagnetic power transmitting device 114, in accordance with an embodiment. The spool 135 can be electromechanically controlled by a motor 134 to retrieve the cable 119 and together with the cable 119 can also help retrieve the electromagnetic power transmitting device 114 from its deployment underneath an electric vehicle 112. The electromagnetic power transmitting device 114 can be retrieved and moved in a stowed position against the docking station 135.

Referring to FIG. 11, illustrated is a top view of a garage 170 with an electric vehicle charging system installment options in front of and at the side of an electric vehicle parked within a garage, carport or bay, in accordance with an embodiment. The docking station 130 can be positioned against a back wall 141 of the garage 170 to assist with deployment and retrieval of the electromagnetic power transmitting device 114 and its cabling 119 from beneath the electric vehicle. The docking station 130′ can also be position against a side wall 142 to assist with the deployment and retrieval of the electromagnetic power transmitting device 114 and its cabling 119′ from beneath the electric vehicle.

Note that the term ‘optical sensor’ as used herein can relate to electro-optical sensors, which are electronic detectors that can detect light, or a change in light, into an electronic signal. These sensors are operable to detect electromagnetic radiation from the infrared up to the ultraviolet wavelengths. An optical sensor may be, for example, a position sensor that can activate when an object interrupts a light beam or a photoelectric sensor that can detect the distance, absence, or presence of an object or target. Optical sensors can also be provided in the form of cameras. A video camera, for example, in combination with artificial intelligence or machine learning can be trained to identify the location of the electromagnetic power receiving device 100 in the form of a charging pad 102 or charging coil 104 on a particular electric vehicle.

Both the electromagnetic power receiving device represented by a charging coil 104 for receiving charge and the electromagnetic power transmitting device represented by a charge transmitting coil 117 can be inductive coils. The charging coil 104 and the charge transmitting coil 117 can be referred to or configured as “loop” antennas, and more specifically, multi-turn loop antennas. The induction coils 104 and 117 can also be referred to herein or be configured as “magnetic” antennas. The term “coil” is intended to refer to a component that can wirelessly output or receive energy four coupling to another “coil.” The coil may be an “antenna” of a type that can be configured to wirelessly output or receive power. Loop (e.g., multi-turn loop) antennas may be configured to include an air core or a physical core such as a ferrite core. An air core loop antenna may allow the placement of other components within the core area. Physical core antennas including ferromagnetic or ferrimagnetic materials may allow development of a stronger electromagnetic field and improved coupling. Note that the use of a loop antenna or “antenna” as discussed above for implementing a coil is not a limiting feature of the embodiments but is discussed herein for exemplary purposes.

Efficient transfer of energy between an electromagnetic power transmitting device (charge transmitting coil) and electromagnetic power receiving device (charge receiving coil) may occur during matched or nearly matched resonance between a transmitter and a receiver. Further, even when resonance between a transmitter and receiver are not matched, energy may be transferred at a lower efficiency. Transfer of energy occurs by coupling energy from the near field of the transmitting induction coil to the receiving induction coil residing within a region (e.g., within a predetermined frequency range of the resonant frequency, or within a predetermined distance of the near-field region) where this near field is established rather than propagating the energy from the transmitting induction coil into free space.

According to some embodiments, coupling power between two induction coils that are in the near field of one another is disclosed. The near field may correspond to a region around the induction coil in which electromagnetic fields exist but may not propagate or radiate away from the induction coil. Near-field coupling-mode regions may correspond to a volume that is near the physical volume of the induction coil, typically within a small fraction of the wavelength. According to some embodiments, electromagnetic induction coils, such as single and multi-turn loop antennas, are used for both transmitting and receiving since magnetic near field amplitudes in practical embodiments tend to be higher for magnetic type coils in comparison to the electric near fields of an electric type antenna (e.g., a small dipole). This allows for potentially higher coupling between the pair. Furthermore, “electric” antennas (e.g., dipoles and monopoles) or a combination of magnetic and electric antennas may be used.

Bidirectional charging between electric vehicle charging stations and electric vehicles has been shown to be useful during situations where power to a premises is lost. Currently, electrically connected charging systems are available that enable the electric vehicle to serve as a power supply for a premises when power is disrupted to the premises. This is only available for physically connected electrically in interfaces, where a charging gun 205 at the end of a cable 203 is plugged into the electric vehicle. It can be appreciated after the detailed teaching contained herein that bidirectional electromagnetic power transfer can occur from the charging pad 100 (coil) located on/in the electric vehicle 112 to the coil associated with the charging member 115, to thereby provide power from the electric vehicle 112 to a premises associated with a charging system as described herein.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

Furthermore, the functionalities including operations, steps, blocks, features, elements and instructions described herein may be implemented entirely and non-abstractly as physical hardware, entirely as physical non-abstract software (including firmware, resident software, micro-code, etc.) or combining non-abstract software and hardware implementations that may all generally be referred to herein as a “circuit,” “module,” “engine”, “component,” “block”, “database”, “agent” or “system.” Furthermore, aspects of the embodiments may take the form of a computer program product embodied in one or more non-ephemeral computer readable media having computer readable and/or executable program code embodied thereon.

Although not required, the disclosed embodiments can be described in the general context of computer-executable instructions, such as program modules, being executed by a single computer. In most instances, a “module” (also referred to as an “engine”) may constitute a software application but can also be implemented as both software and hardware (i.e., a combination of software and hardware).

Generally, modules implemented as program modules may include, but are not limited to, routines, subroutines, software applications, programs, objects, components, data structures, etc., that can perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein can refer to a collection of routines and data structures, which can perform a particular task or can implement a particular data type. A module can be composed of two parts: an interface, which lists the constants, data types, variable, and routines that can be accessed by other modules or routines, and an implementation, which is typically private (accessible only to that module), and which includes source code that actually implements the routines in the module. The term module may also simply refer to an application, such as a computer program designed to assist in the performance of a specific task, such as word processing, accounting, inventory management, etc.

In some example embodiments, the term “module” can also refer to a modular hardware component or a component that can be a combination of hardware and software. It should be appreciated that implementation and processing of the disclosed modules, whether primarily software-based and/or hardware-based or a combination thereof, according to the approach described herein can lead to improvements in processing speed and ultimately in energy savings and efficiencies in the underlying technology.

It will be understood that the appropriate circuits may be used in alternative embodiments depending on the circumstances in which the respective wireless power transfer system is expected to operate. This disclosure is not limited to any particular configuration of tuning reactive elements used in conjunction with an inductive power transfer circuit, and the parallel tuned, series tuned, and LCL tuned resonant circuits are provided herein by way of example only. Furthermore, the disclosure is not limited to any particular receiver-side means of generating a current in the receiver inductor and the voltage transformer, current transformer, and reversible rectifier techniques are discussed herein by way of example only.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer. An example of such a receiving coil is, for example, the charging coil 104.

An electric vehicle may be a remote system, an example of which can include, as part of its locomotion capabilities, electrical power derived from a chargeable energy storage device (e.g., one or more rechargeable electrochemical cells or other type of battery). As examples, some electric vehicles may be hybrid electric vehicles that include a traditional combustion engine for direct locomotion or to charge the vehicle's battery. Other electric vehicles may draw all locomotion ability from electrical power. An electric vehicle is not limited to an automobile and may include motorcycles, carts, scooters, and the like. By way of example and not limitation, a remote system is described herein in the form of an electric vehicle (EV). Furthermore, other remote systems that may be at least partially powered using a chargeable energy storage device are also contemplated (for example, electronic devices such as personal computing devices and the like).

The various operations of methods, systems and devices described above may be performed by any suitable means capable of performing the operations, such as various hardware and/or software component(s), circuits, and/or module(s). Generally, any operations illustrated in the figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The blocks or steps/instructions of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

Based on the foregoing, it can be appreciated that a number of embodiments including preferred and alternative embodiments, are disclosed herein. For example, in an embodiment an apparatus for charging an electric vehicle, can include an electromagnetic power transmitting device that is moveable in an X-Y-Z direction from a ground position underneath an electric vehicle to interface with an electromagnetic power receiving device coupled to an undersurface of the electric vehicle. The electromagnetic power transmitting device is operable to automatically move towards and find a target area underneath the electric vehicle associated with a charge receiving coil integrated with the electromagnetic power receiving device and connected to the electric vehicle for the charging of an electric vehicle when the electromagnetic power transmitting device engages with the electromagnetic power receiving device.

In an embodiment, the charge transmitting device can automatically disengage from the electromagnetic power receiving device and retract to a docking station after charging of the electric vehicle.

In an embodiment, the target area can include an electromagnetic field.

In an embodiment, the target area can include a radio frequency.

In an embodiment, the target area may include an optically recognizable target.

In another embodiment, a method for charging an electric vehicle, can involve: moving an electromagnetic power transmitting device in an X-Y-Z direction from a ground position underneath an electric vehicle to interface with an electromagnetic power receiving device coupled to an undersurface of the electric vehicle; and moving the electromagnetic power transmitting device to find a target area underneath the electric vehicle associated with a charge receiving coil integrated with the electromagnetic power receiving device and connected to the electric vehicle for the charging of the electric vehicle when the electromagnetic power transmitting device engages with the electromagnetic power receiving device.

Note that the aforementioned ‘moving’ steps or operations may be performed with the assistance of a robotic device, i.e., a robot or robotic system. Such ‘moving’ steps or operations may in some operations be performed automatically. The robotic device, robot or robotic system may be, for example, a manipulatable robotic charging platform.

An embodiment of the method may also involve automatically disengaging the charge transmitting device from the electromagnetic power receiving device and retracting the charge transmitting device to a docking station after charging of the electric vehicle.

In an embodiment of the method, the target area may comprise an electromagnetic field.

In an embodiment of the method, the target area may include an electromagnetic target.

In an embodiment of the method, target area may include a radio frequency (RF) target.

In an embodiment of the method, the target area may be an optically recognizable target.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

The citation or identification of any reference herein, or any section of this application shall not be construed as an admission that such reference is available as prior art. The disclosure of each publication, patent, and/or other references herein are hereby incorporated by reference in their entirety in this application and shall be treated as if the entirety thereof forms a part of this application. Such references are provided for their disclosure of technologies as may be required to enable practice of the present invention, to provide written description for claim language, to make clear applicant's possession of the invention with respect to the various aggregates, combinations, permutations, and subcombinations of the respective disclosures or portions thereof (within a particular reference or across multiple references) in conjunction with the combinations, permutations, and subcombinations of various disclosure provided herein, to demonstrate the technological non-abstract nature of the inventions claimed, and for any other purpose.

Except as expressly indicated, the scope of the invention is inclusive, and therefore the disclosure of a technology or teaching within these incorporated materials is intended to encompass that technology or teaching as being an option of, or an addition to, other disclosure of the present invention. Likewise, the combination of incorporated teachings consistent with this disclosure is also encompassed. The citation of references is intended to be part of the disclosure of the invention, and not merely supplementary background information. While cited references may be prior art, the combinations thereof and with the material disclosed herein is not admitted as being prior art.

The incorporation by reference herein does not extend to teachings which may be inconsistent with the invention as expressly described herein as being essential. The incorporated references are rebuttable evidence of a proper interpretation of terms, phrases, and concepts employed herein by persons of ordinary skill in the art. No admission is made that any incorporated reference is analogous art to the issues presented to the inventor, and the selection, combination, and disclosure of these disparate teachings may be itself a part of the embodiments.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. An apparatus for charging an electric vehicle, comprising:
an electromagnetic power transmitting device moveable in an X-Y-Z direction from a ground position underneath an electric vehicle to interface with an electromagnetic power receiving device coupled to an undersurface of the electric vehicle, wherein the electromagnetic power transmitting device is operable to automatically move towards and find a target area underneath the electric vehicle associated with a charge receiving coil integrated with the electromagnetic power receiving device and connected to the electric vehicle for the charging of the electric vehicle when the electromagnetic power transmitting device engages with the electromagnetic power receiving device.

2. The apparatus of claim 1, wherein the charge transmitting device automatically disengages from the electromagnetic power receiving device and retracts to a docking station after charging of the electric vehicle is complete.

3. The apparatus of claim 1, wherein the target area comprises an electromagnetic field.

4. The apparatus of claim 1, wherein the target area comprises an electromagnetic target.

5. The apparatus of claim 1, wherein the target area comprises a radio frequency (RF) target.

6. The apparatus of claim 1, wherein the target area comprises an optically recognizable target.

7. The apparatus of claim 1, wherein the target area comprises at least one of: an electromagnetic target, an radio frequency (RF) target, or an optically recognizable target.

8. A method for charging an electric vehicle, comprising:
moving an electromagnetic power transmitting device in an X-Y-Z direction from a ground position underneath an electric vehicle to interface with an electromagnetic power receiving device coupled to an undersurface of the electric vehicle; and
moving the electromagnetic power transmitting device to find a target area underneath the electric vehicle associated with a charge receiving coil integrated with the electromagnetic power receiving device and connected to the electric vehicle for the charging of the electric vehicle when the electromagnetic power transmitting device engages with the electromagnetic power receiving device.

9. The method of claim 8 automatically disengaging the charge transmitting device from the electromagnetic power receiving device and retracting the charge transmitting device to a docking station after charging of the electric vehicle.

10. The method of claim 8, wherein the target area comprises an electromagnetic field.

11. The method of claim 8, wherein the target area comprises an electromagnetic target.

12. The method of claim 8, wherein the target area comprises a radio frequency (RF) target.

13. The method of claim 8, wherein the target area comprises an optically recognizable target.

14. The method of claim 8, wherein the target area comprises at least one of: an electromagnetic target, an radio frequency (RF) target, or an optically recognizable target.
